(19) United States
(12) Patent Application Publication
(10) Pub. No.: US 2018/0200127 A1
(43) Pub. Date: Jul. 19, 2018

(54) Safety Belt System for Paratransit Lifts

(71) Applicants: Dale Binkley, Frederick, CO (US); Ralph Mason, Westminister, CO (US)

(72) Inventors: Dale Binkley, Frederick, CO (US); Ralph Mason, Westminister, CO (US)

(21) Appl. No.: 15/873,771

(22) Filed: Jan. 17, 2018

Related U.S. Application Data
(60) Provisional application No. 62/446,972, filed on Jan. 17, 2017.

(51) Int. Cl. A61G 3/08; A61G 3/06

(52) U.S. Cl. CPC A61G 3/0808; B60P 1/4457; A61G 3/06

(57) ABSTRACT

A safety belt system for paratransit lifts uses a front lift strap and a rear lift strap. The front lift strap and the rear lift strap are safety belts that can be connected in front of and behind a wheelchair that is mounted onto a lift platform of a paratransit lift. The front lift strap and the rear lift strap are identical, and each has a pair of length-adjustable webbings, a quick-release buckle, and a pair of lift-connection mechanisms. The quick-release buckle is connected in between the pair of length-adjustable webbings so that the two length-adjustable webbings are terminally connected to each other. Each lift-connection mechanism is terminally connected to a length-adjustable webbing, opposite to the quick-release buckle. As a result, the length-adjustable webbings can be connected to each other and then connected to the paratransit lift.

The current application claims a priority to the U.S. Provisional Patent application Ser. No. 62/446,972 filed on Jan. 17, 2017.

### FIELD OF THE INVENTION

The present invention relates generally to safety belts. More particularly, the present invention is related to safety belts that prevent a wheelchair from falling off of the platform of a paratransit lift.

### BACKGROUND OF THE INVENTION

Paratransit lifts typically provide an elevating platform onto which a person with limited personal mobility may be positioned for transfer between ground level and a floor of a vehicle. For example, the limited-mobility person may be in a wheel chair or may use a walker. The person may enter the platform with or without assistance. In either case, there is a risk that the person and/or the person's wheel chair may not remain securely on the platform as the platform moves to an elevated or lowered position. As can be seen, there is a need for a safety system that may be employed to assure that an occupant of a paratransit lift platform may be prevented from accidentally falling from the platform. Additionally, there is a need for such a system that may be conveniently used by an operator of the lift and does not require modifications of the lift which might require regulatory re-certification of the lift.

### BRIEF DESCRIPTION OF THE DRAWINGS

FIG. 1 is a perspective view of the lift straps of present invention where the lift-connection mechanisms are loop straps which are in an extended configuration.

FIG. 2 is a perspective view of the lift straps of present invention where the lift-connection mechanisms are loop straps which are in a looped configuration.

FIG. 3 is a perspective view of the lift straps of present invention where the quick-release buckle is engaged, and the lift-connection mechanisms are loop straps which are in a looped configuration.

FIG. 4 is a perspective view of the lift straps of present invention where each lift-connection mechanism comprises a connection hole and a connection grommet.

FIG. 5 is a perspective view of the paratransit lift with the lift straps attached.

### DETAIL DESCRIPTIONS OF THE INVENTION

All illustrations of the drawings are for the purpose of describing selected versions of the present invention and are not intended to limit the scope of the present invention.

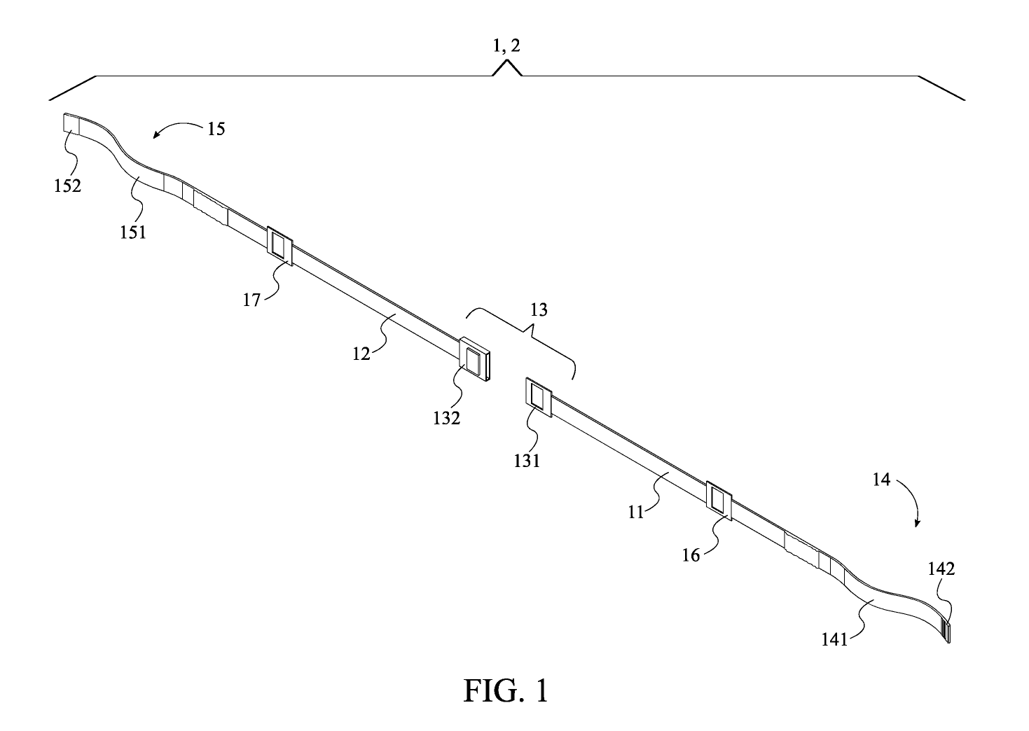

Referring to FIG. 1 through FIG. 5, the preferred embodiment of the present invention, the safety belt system for paratransit lifts, uses detachable straps to secure a wheelchair on a lift platform 33 of a paratransit lift 3. To accomplish this, the present invention comprises a front lift strap 1 and a rear lift strap 2. The front lift strap 1 is designed to be mounted in front of the wheelchair to prevent the wheelchair from rolling off of the front end of the lift platform 33. Similarly, the rear lift strap 2 is designed to be mounted behind the wheelchair to prevent the wheelchair from rolling off of the rear end of the lift platform 33. The front lift strap 1 is constructed identically to the rear lift strap 2, and each comprises a first length-adjustable webbing 11, a second length-adjustable webbing 12, a quick-release buckle 13, a first lift-connection mechanism 14, and a second lift-connection mechanism 15. The front lift strap 1 and the rear lift strap 2 are each formed from two pieces of webbing that are connected by a detachable fastener. Specifically, the quick-release buckle 13 is terminally connected to the first length-adjustable webbing 11. Additionally, the second length-adjustable webbing 12 is terminally connected to the quick-release buckle 13, opposite to the first length-adjustable webbing 11. As a result, the first length-adjustable webbing 11 and the second length-adjustable webbing 12 can be formed into a continuous strip by engaging the quick-release buckle 13. Conversely, the first length-adjustable webbing 11 can be disconnected from the second length-adjustable webbing 12 by disengaging the quick-release buckle 13. The first lift-connection mechanism 14 and the second lift-connection mechanism 15 are fastening devices used to mount the first length-adjustable webbing 11 and the second length-adjustable webbing 12 onto the paratransit lift 3. Specifically, the first lift-connection mechanism 14 is terminally attached to the first length-adjustable webbing 11, opposite to the quick-release buckle 13. Accordingly, the first length-adjustable webbing 11 can be mounted onto the paratransit lift 3 by attaching the first lift-connection mechanism 14 to the paratransit lift 3. Likewise, the second lift-connection mechanism 15 is terminally attached to the second length-adjustable webbing 12, opposite to the quick-release buckle 13. Consequently, the second length-adjustable webbing 12 can be mounted onto the paratransit lift 3 by attaching the second lift-connection mechanism 15 to the paratransit lift 3. Further, the front lift strap 1 is mounted offset from the rear lift strap 2. Thus positioned, the front lift strap 1 and the rear lift strap 2 serve as braces that can be attached to secure the wheelchair on the lift platform 33. Conversely, the front lift strap 1 and the rear lift strap 2 can be detached to enable the wheelchair to be removed from the lift platform 33.

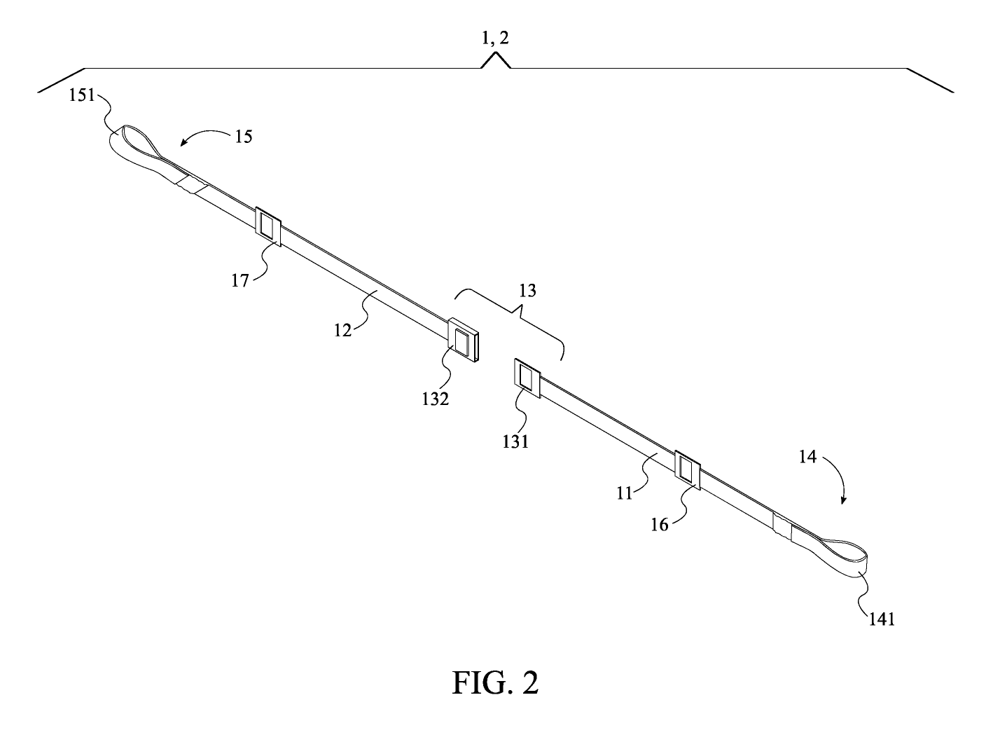

Referring to FIG. 1 and FIG. 2, the preferred embodiment of the present invention is designed to be attached to paratransit lifts of varying shape and size. To facilitate this, the present invention comprises a first length-adjustment mechanism 16 and a second length-adjustment mechanism 17. Preferably, the first length-adjustment mechanism 16 and the second length-adjustment mechanism 17 are buckles that enable the length of a strap to be modified by a user. In the present invention, the first length-adjustment mechanism 16 is mechanically integrated along the first length-adjustable webbing 11. Accordingly, the first length-adjustment mechanism 16 enables the user to modify the overall length of the first length-adjustable webbing 11. Likewise, the second length-adjustment mechanism 17 is mechanically integrated along the second length-adjustable webbing 12. As a result, the second length-adjustment mechanism 17 enables the user to modify the overall length of the second length-adjustable webbing 12. The first length-adjustment mechanism 16 and the second length-adjustment mechanism 17 enable the lengths of the first length-adjustable webbing 11 and the second length-adjustable webbing 12 to be modified such that the two pieces of webbing can be connected across distances of varying length.

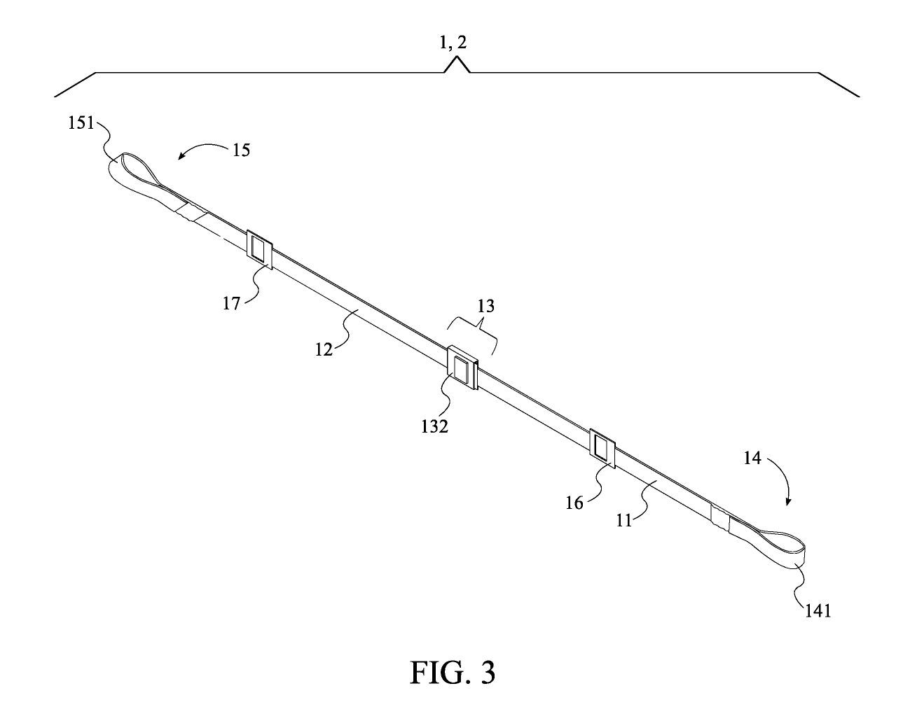

Referring to FIG. 1 and FIG. 3, the quick-release buckle 13 is designed to facilitate forming a detachable connection between the first length-adjustable webbing 11 and the second length-adjustable webbing 12. To accomplish this, the quick-release buckle 13 comprises an interlocking prong 131 and an interlocking receptacle 132. The interlocking prong 131 and the interlocking receptacle 132 form two interlocking halves of the quick-release buckle 13. As such, the interlocking prong 131 is adjacently connected to the first length-adjustable webbing 11. Additionally, the interlocking receptacle 132 is adjacently connected to the second length-adjustable webbing 12. As a result, the first length-adjustable webbing 11 can be attached to the second length-adjustable webbing 12 by inserting the interlocking prong 131 into the interlocking receptacle 132. Specifically, interlocking prong 131 is mechanically engaged within the interlocking receptacle 132 so that the interlocking prong 131 can only be disengaged from the interlocking receptacle 132 by the application of an external force.

Referring to FIG. 1, FIG. 2, and FIG. 3, the present invention is designed such that various types of fastening systems can function as the first lift-connection mechanism 14 and the second lift-connection mechanism 15. For example, the lift-connection mechanisms can be formed from straps with hook-and-loop fasteners which secure the strap around the lateral surface of a first handle 34 or post. Alternatively, the lift-connection mechanisms can be formed from fasteners including, but not limited to, buttons, quick-release connectors, clasps, snaps, and magnetic connectors. In a first alternative embodiment of the present invention, the first lift-connection mechanism 14 comprises a first loop strap 141 and a first loop fastener 142. The first length-adjustable webbing 11 is terminally connected to the first loop strap 141. Thus positioned, the first loop strap 141 enables the end of the first length-adjustable webbing 11, which is positioned opposite to the quick-release buckle 13, to be wrapped around the lateral surface of the first handle 34. To facilitate securing the first loop strap 141 to the first handle 34, the first loop fastener 142 is terminally connected to the first loop strap 141, opposite to the first length-adjustable webbing 11. Thus positioned, the first loop fastener 142 enables the first loop strap 141 to form a closed loop around the lateral surface of the first handle 34. Additionally, the first loop fastener 142 enables the user to cinch the first loop strap 141 around the lateral surface of the first handle 34.

Referring to FIG. 1, FIG. 2, and FIG. 3, furthermore, in the first alternative embodiment of the present invention, the second lift-connection mechanism 15 comprises a second loop strap 151 and a second loop fastener 152. The second length-adjustable webbing 12 is terminally connected to the second loop strap 151. Thus positioned, the second loop strap 151 enables the end of the second length-adjustable webbing 12, which is positioned opposite to the quick-release buckle 13, to be wrapped around the lateral surface of a second handle 35 or post. To facilitate securing the second loop strap 151 to the second handle 35, the second loop fastener 152 is terminally connected to the second loop strap 151, opposite to the second length-adjustable webbing 12. Thus positioned, the second loop fastener 152 enables the second loop strap 151 to form a closed loop around the lateral surface of the second handle 35. Additionally, the second loop fastener 152 enables the user to cinch the second loop strap 151 around the lateral surface of the second handle 35.

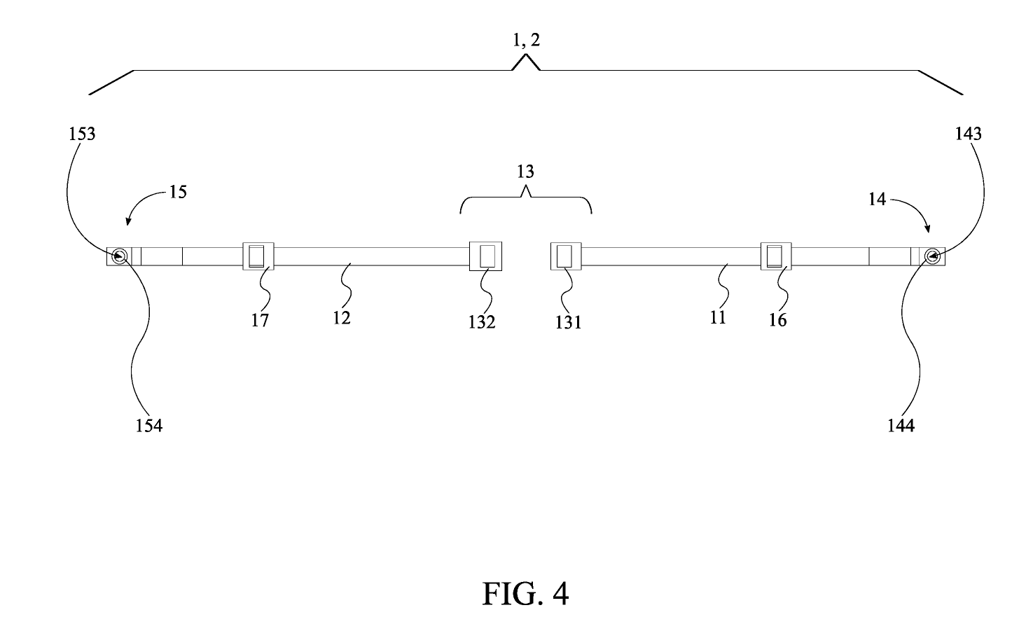

Referring to FIG. 1 and FIG. 4, in a second alternative embodiment of the present invention, the first lift-connection mechanism 14 and the second lift-connection mechanism 15 are reinforced holes that enable the first length-adjustable webbing 11 and the second length-adjustable webbing 12 to be mounted onto hooks, bolts, and pegs. Specifically, in the second alternative embodiment, the first lift-connection mechanism 14 comprises a first connector hole 143 and a first grommet 144. The first connector hole 143 traverses through the first length-adjustable webbing 11. So that a hook, a bolt, or a peg can be passed through the first length-adjustable webbing 11. Additionally, the first grommet 144 is perimetrically connected to the first length-adjustable webbing 11 about the first connector hole 143. Consequently, the first grommet 144 reinforces the first connector hole 143.

Referring to FIG. 1 and FIG. 4, further, in the second alternative embodiment of the present invention, the second lift-connection mechanism 15 and the second lift-connection mechanism 15 are reinforced holes that enable the second length-adjustable webbing 12 and the second length-adjustable webbing 12 to be mounted onto hooks, bolts, and pegs. Specifically, in the second alternative embodiment, the second lift-connection mechanism 15 comprises a second connector hole 153 and a second grommet 154. The second connector hole 153 traverses through the second length-adjustable webbing 12. So that a hook, a bolt, or a peg can be passed through the second length-adjustable webbing 12. Additionally, the second grommet 154 is perimetrically connected to the second length-adjustable webbing 12 about the second connector hole 153. Consequently, the second grommet 154 reinforces the second connector hole 153.

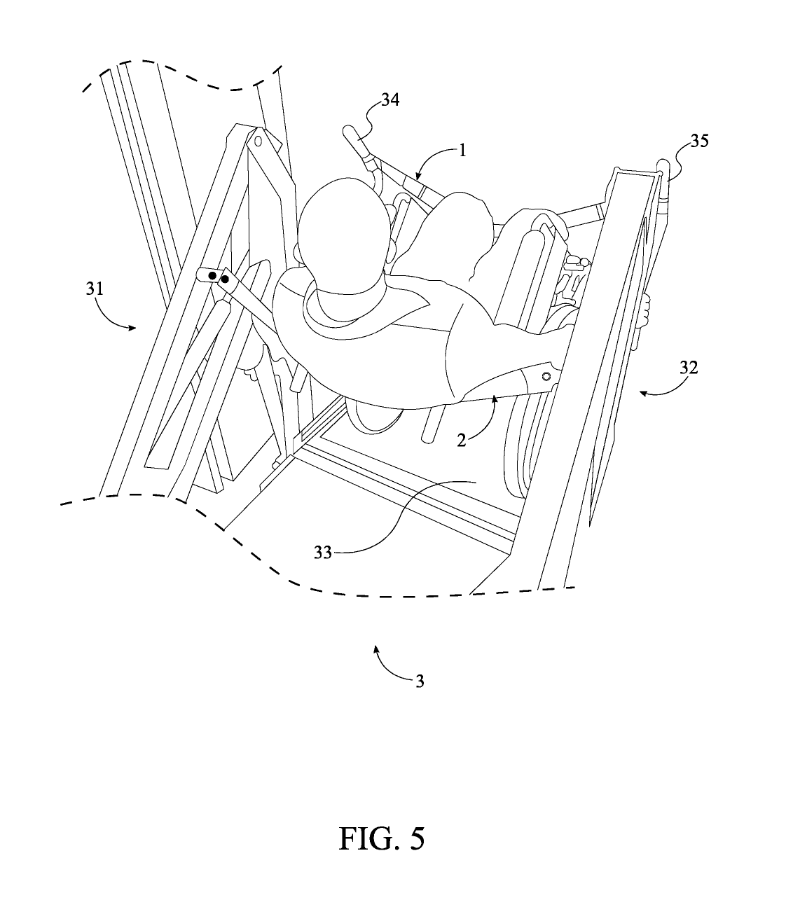

Referring to FIG. 1 and FIG. 5, as described above, the present invention is designed to be secure a wheelchair and the wheelchair's occupant on the lift platform 33 of the paratransit lift 3. The front lift strap 1 and the rear lift strap 2 are adapted to be attached to the paratransit lift 3 in front of and behind the wheelchair, such that the wheelchair is prevented from rolling off of the lift platform 33. Specifically, the present invention is designed to be attached to a paratransit lift 3 that comprises a first lifting-arm assembly 31, a second lifting-arm assembly 32, a lift platform 33, a first handle 34 and a second handle 35. Preferably, the components of the paratransit lift 3 are arranged thus; the lift platform 33 is connected in between the first lifting-arm assembly 31 and the second lifting-arm assembly 32 so that the lift platform 33 can be raised and lowered by the first lifting-arm assembly 31 and the second lifting-arm assembly 32. The first lifting-arm assembly 31 and the second lifting-arm assembly 32 are articulated mechanisms capable of transitioning the lift platform 33 between positions that facilitate lifting a wheelchair, and storing the paratransit lift 3 while not in use. The first lifting-arm assembly 31 is terminally connected to the first handle 34. Additionally, the first handle 34 is positioned offset from the lift platform 33 across the first lifting-arm assembly 31. As a result, the first handle 34 is positioned such that the occupant of the wheelchair can grasp the handle for support during transit. Similarly, the second lifting-arm assembly 32 is terminally connected to the second handle 35. Additionally, the second handle 35 is positioned offset from the lift platform 33 across the second lifting-arm assembly 32. As a result, the second handle 35 is positioned such that the occupant of the wheelchair can grasp the handle for support during transit. Furthermore, the first handle 34 and the second handle 35 are positioned on opposite sides of the wheelchair. The front lift strap 1 is connected in between the first handle 34 and the second handle 35. Accordingly, the front lift strap 1 prevents the wheelchair from rolling off of the front end of the lift platform 33 until the quick-release buckle 13 is disengaged. Additionally, the rear lift strap 2 is connected in between the first lifting-arm assembly 31 and the second lifting-arm assembly 32. Thus connected, the rear lift strap 2 prevents the wheelchair from rolling off of the rear end of the lift platform 33 until the quick-release buckle 13 is disengaged. The system for implementing the present invention is deployed when the wheelchair is mounted onto the lift platform 33, such that the wheelchair is positioned in between the first lifting-arm assembly 31 and the second lifting-arm assembly 32. Additionally, the wheelchair is positioned in between the front lift strap 1 and the rear lift strap 2 so that the wheelchair is prevented from falling off of the front end or the rear end of the lift platform 33.

Referring to FIG. 1 and FIG. 5, the first lift-connection mechanism 14 and the second lift-connection mechanism 15 of the front lift strap 1 are used to attach the front strap to the first handle 34 and the second handle 35. Specifically, the first connection mechanism of the front lift strap 1 is laterally attached to the first handle 34. Additionally, the second connection mechanism of the front lift strap 1 is laterally attached to the second handle 35. Thus, the front lift strap 1 is securely affixed between the first handle 34 and the second handle 35. Relatedly, the first lift-connection mechanism 14 and the second lift-connection mechanism 15 of the rear lift strap 2 are used to attach the rear lift strap 2 to the first lifting-arm assembly 31 and the second lifting-arm assembly 32. Specifically, the first connection mechanism of the rear lift strap 2 is laterally attached to the first lifting-arm assembly 31. Additionally, the second connection mechanism of the rear lift strap 2 is laterally attached to the second lifting-arm assembly 32. Thus, the rear lift strap 2 is securely affixed between the first lifting-arm assembly 31 and the second lifting-arm assembly 32.

Although the invention has been explained in relation to its preferred embodiment, it is to be understood that many other possible modifications and variations can be made without departing from the spirit and scope of the invention as hereinafter claimed.

What is claimed is:

1. A safety belt system for paratransit lifts comprises:
a front lift strap;
a rear lift strap;
the front lift strap and the rear lift strap each comprise a first length-adjustable webbing, a second length-adjustable webbing, a quick-release buckle, a first lift-connection mechanism, and a second lift-connection mechanism;
the quick-release buckle being terminally connected to the first length-adjustable webbing;
the second length-adjustable webbing being terminally connected to the quick-release buckle, opposite to the first length-adjustable webbing;
the first lift-connection mechanism being terminally attached to the first length-adjustable webbing, opposite to the quick-release buckle;
the second lift-connection mechanism being terminally attached to the second length-adjustable webbing, opposite to the quick-release buckle; and
the front lift strap being mounted offset from the rear lift strap.

2. The safety belt system for paratransit lifts as claimed in claim 1 comprises:
the front lift strap and the rear lift strap each further comprise a first length-adjustment mechanism; and
the first length-adjustment mechanism being mechanically integrated along the first length-adjustable webbing.

3. The safety belt system for paratransit lifts as claimed in claim 1 comprises:
the front lift strap and the rear lift strap each further comprise a second length-adjustment mechanism; and
the second length-adjustment mechanism being mechanically integrated along the second length-adjustable webbing.

4. The safety belt system for paratransit lifts as claimed in claim 1 comprises:
the quick-release buckle comprises an interlocking prong and an interlocking receptacle;
the interlocking prong being adjacently connected to the first length-adjustable webbing;
the interlocking receptacle being adjacently connected to the second length-adjustable webbing; and
the interlocking prong being mechanically engaged within the interlocking receptacle.

5. The safety belt system for paratransit lifts as claimed in claim 1 comprises:
the first lift-connection mechanism comprises a first loop strap and a first loop fastener;
the first length-adjustable webbing being terminally connected to the first loop strap; and
the first loop fastener being terminally connected to the first loop strap, opposite to the first length-adjustable webbing.

6. The safety belt system for paratransit lifts as claimed in claim 1 comprises:
the second lift-connection mechanism comprises a second loop strap and a second loop fastener;
the second length-adjustable webbing being terminally connected to the second loop strap;
the second loop fastener being terminally connected to the second loop strap, opposite to the second length-adjustable webbing; and
the second interlocking prong being adjacently connected to the second length-adjustable webbing.

7. The safety belt system for paratransit lifts as claimed in claim 1 comprises:
the first lift-connection mechanism comprises a first connector hole and a first grommet;
the first connector hole traversing through the first length-adjustable webbing; and
the first grommet being perimetrically connected to the first length-adjustable webbing about the first connector hole.

8. The safety belt system for paratransit lifts as claimed in claim 1 comprises:
the second lift-connection mechanism comprises a second connector hole and a second grommet;
the second connector hole traversing through the second length-adjustable webbing; and
the second grommet being perimetrically connected to the second length-adjustable webbing about the second connector hole.

9. The safety belt system for paratransit lifts as claimed in claim 1 comprises:
a paratransit lift;
a wheelchair;
the paratransit lift comprises a first lifting-arm assembly, a second lifting-arm assembly, a lift platform, a first handle and a second handle;
the lift platform being connected in between the first lifting-arm assembly and the second lifting-arm assembly;
the first lifting-arm assembly being terminally connected to the first handle;
the first handle being positioned offset from the lift platform across the first lifting-arm assembly;
the second lifting-arm assembly being terminally connected to the second handle;
the second handle being positioned offset from the lift platform across the second lifting-arm assembly;
the front lift strap being connected in between the first handle and the second handle;
the rear lift strap being connected in between the first lifting-arm assembly and the second lifting-arm assembly;
the wheelchair being mounted onto the lift platform;
the wheelchair being positioned in between the first lifting-arm assembly and the second lifting-arm assembly; and
the wheelchair being positioned in between the front lift strap and the rear lift strap.

10. The safety belt system for paratransit lifts as claimed in claim 9 comprises:
the first connection mechanism of the front lift strap being laterally attached to the first handle; and
the second connection mechanism of the front lift strap being laterally attached to the second handle.

11. The safety belt system for paratransit lifts as claimed in claim 9 comprises:
the first connection mechanism of the rear lift strap being laterally attached to the first lifting-arm assembly; and
the second connection mechanism of the rear lift strap being laterally attached to the second lifting-arm assembly.

12. A strapping system for paratransit lifts comprises:
a front lift strap;
a rear lift strap;
the front lift strap and the rear lift strap each comprise a first length-adjustable webbing, a second length-adjustable webbing, a quick-release buckle, a first lift-connection mechanism, a second lift-connection mechanism, a first length-adjustment mechanism, and a second length-adjustment mechanism;
the quick-release buckle being terminally connected to the first length-adjustable webbing;
the second length-adjustable webbing being terminally connected to the quick-release buckle, opposite to the first length-adjustable webbing;
the first lift-connection mechanism being terminally attached to the first length-adjustable webbing, opposite to the quick-release buckle;
the second lift-connection mechanism being terminally attached to the second length-adjustable webbing, opposite to the quick-release buckle;
the front lift strap being mounted offset from the rear lift strap;
the first length-adjustment mechanism being mechanically integrated along the first length-adjustable webbing; and
the second length-adjustment mechanism being mechanically integrated along the second length-adjustable webbing.

13. The strapping system for paratransit lifts as claimed in claim 12 comprises:
the quick-release buckle comprises an interlocking prong and an interlocking receptacle;
the interlocking prong being adjacently connected to the first length-adjustable webbing;
the interlocking receptacle being adjacently connected to the second length-adjustable webbing; and
the interlocking prong being mechanically engaged within the interlocking receptacle.

14. The strapping system for paratransit lifts as claimed in claim 12 comprises:
the first lift-connection mechanism comprises a first loop strap and a first loop fastener;
the first length-adjustable webbing being terminally connected to the first loop strap; and
the first loop fastener being terminally connected to the first loop strap, opposite to the first length-adjustable webbing.

15. The strapping system for paratransit lifts as claimed in claim 12 comprises:
the second lift-connection mechanism comprises a second loop strap and a second loop fastener;
the second length-adjustable webbing being terminally connected to the second loop strap;
the second loop fastener being terminally connected to the second loop strap, opposite to the second length-adjustable webbing; and
the second interlocking prong being adjacently connected to the second length-adjustable webbing.

16. The strapping system for paratransit lifts as claimed in claim 12 comprises:
the first lift-connection mechanism comprises a first connector hole and a first grommet;
the first connector hole traversing through the first length-adjustable webbing; and
the first grommet being perimetrically connected to the first length-adjustable webbing about the first connector hole.

17. The strapping system for paratransit lifts as claimed in claim 12 comprises:
the second lift-connection mechanism comprises a second connector hole and a second grommet;
the second connector hole traversing through the second length-adjustable webbing; and
the second grommet being perimetrically connected to the second length-adjustable webbing about the second connector hole.

18. The strapping system for paratransit lifts as claimed in claim 1 comprises:
a paratransit lift;
a wheelchair;
the paratransit lift comprises a first lifting-arm assembly, a second lifting-arm assembly, a lift platform, a first handle and a second handle;
the lift platform being connected in between the first lifting-arm assembly and the second lifting-arm assembly;
the first lifting-arm assembly being terminally connected to the first handle;
the first handle being positioned offset from the lift platform across the first lifting-arm assembly;
the second lifting-arm assembly being terminally connected to the second handle;
the second handle being positioned offset from the lift platform across the second lifting-arm assembly;
the front lift strap being connected in between the first handle and the second handle;
the rear lift strap being connected in between the first lifting-arm assembly and the second lifting-arm assembly;
the wheelchair being mounted onto the lift platform;
the wheelchair being positioned in between the first lifting-arm assembly and the second lifting-arm assembly; and
the wheelchair being positioned in between the front lift strap and the rear lift strap.

19. The strapping system for paratransit lifts as claimed in claim 18 comprises:
the first connection mechanism of the front lift strap being laterally attached to the first handle; and
the second connection mechanism of the front lift strap being laterally attached to the second handle.

20. The strapping system for paratransit lifts as claimed in claim 18 comprises:
the first connection mechanism of the rear lift strap being laterally attached to the first lifting-arm assembly; and
the second connection mechanism of the rear lift strap being laterally attached to the second lifting-arm assembly.
